(19) United States
(12) Patent Application Publication
(10) Pub. No.: US 2020/0400128 A1
(43) Pub. Date: Dec. 24, 2020

(54) Method for Improving Reporting of Operational Data of a Wind Turbine

(71) Applicant: SCADA INTERNATIONAL A/S, Silkeborg (DK)

(72) Inventor: Bo Lovmand, Hadsten (DK)

(21) Appl. No.: 17/012,512

(22) Filed: Sep. 4, 2020

Related U.S. Application Data
(63) Continuation of application No. PCT/DK2019/050281, filed on Sep. 23, 2019.

(30) Foreign Application Priority Data
Sep. 25, 2018 (DK) PA 2018 00635

(51) Int. Cl. F03D 17/00; G06Q 50/06

(52) U.S. Cl. CPC F03D 17/00; G06Q 50/06

(57) ABSTRACT

The invention relates to a method for improving reporting of operational data from a wind turbine during operation thereof; said method comprising the steps of:
i) controlling the operation of said wind turbine by using a control system;
ii) in respect of a predetermined time segment allowing one or more sensors to sense one or more parameter values representing the magnitude of power production of said wind turbine and allowing said sensors to transmit said one or more parameter values to said control system;
iii) from said one or more parameter values transmitted to said control system in step ii), allowing said control system to determine a total production of energy within said time segment;
iv) from said one or more parameter values transmitted to said control system, allowing said control system to determine an accumulated value, representing an accumulated production of energy by said wind turbine until the end of said specific time segment;
v) allowing said control system to transmit, to a monitoring system, data determined in step iii) and iv);
vi) repeat steps i)-v) in respect of subsequent time segments;
vii) in respect of a time span comprising several of said time segments, allowing said monitoring system to assess the reliability of data relating to the total production of energy in a specific time segment of said time span, and optionally allowing said monitoring system to correct such data in case such information is assessed as being unreliable, thereby obtaining corrected data relating to an estimated total production of energy in respect of one or more specific time segments within said time span.

### FIELD OF THE INVENTION

The present invention relates in general to the field of wind turbines. More specifically the present invention relates in a first aspect to a method for improving reporting of operational data from a wind turbine during operation thereof.

In a second aspect the present invention relates to the use of interpolation of data relating to accumulated total energy produced by a wind turbine in respect of two time segments determining an estimated total energy production in respect of said specific time segment.

In a third aspect the present invention relates to a computer program product being configured for performing a method according to the first aspect of the present invention.

In a fourth aspect the present invention relates to a SCADA system (Supervisory Control And Data Acquisition System).

### BACKGROUND OF THE INVENTION

Within the field of wind turbines and the operation thereof it is customary that the manufacturer which has manufactured the wind turbine or pats thereof is/are different from the company responsible for operating the wind turbine or wind farm.

In order to secure or guarantee the operator's viable economy in respect of operating a wind turbine or a wind farm it is customary that a contract is agreed between the manufacturer of the wind turbine or parts thereof one the one hand and the operator of the wind turbine or wind farm, on the other hand.

In such a contract it is stipulated which types of faults, errors and special conditions leading to missing or reduced power production is the responsibility of the producer and which types of faults, errors and special conditions leading to missing or reduced power production is the responsibility of the operator.

Typically, such a contract will also contain detailed calculation schedule dividing the value represented by the power produced by a wind turbine between the manufacturer and the operator according to predetermined schedule of allocations. Hereby the manufacturer will have an incentive to continuously improve the quality of the components making up the wind turbine in order to reduce the downtime of the wind turbine. This will eventually secure an optimum energy production.

A wind turbine is operated by the use of a control system which monitors a vast number of parameters associated with the operation of the wind turbine.

The monitoring of the parameters is performed by using a number of sensors arranged in and on the wind turbine. Each sensor is responsible for sensing a specific parameter or group of parameters.

The control system is configured to use the parameters sensed by the sensors as inputs in the calculation of a feedback procedure. In this way a wind turbine can be operated automatically according to a predetermined algorithm using monitored parameters, sensed by sensor, to create a feedback response which in turn is used for controlling the wind turbine.

In addition to using the parameters sensed by the sensors as inputs in the calculation of a feedback procedure for controlling the wind turbine, the control system is also configured, from the sensed parameters, to determine whether or not a critical event has happened.

A critical even will make the control system instruct the wind turbine to shut down, i.e. to bring the wind turbine into a state in which the rotor stops rotating so that no power is being produced.

Many different parameter values sensed by the sensors, or combination thereof, may lead to a situation in which the control system has been predetermined to identify a critical event and subsequently shut down the wind turbine. Each such critical event situation is associated with an associated alarm ID, identifying which type of critical event is the cause for shutting down the wind turbine.

The sensors may also individually or collectively sense situations in respect of which the control system has been configured to transmit a warning signal, meaning that some operational parameters of the wind turbine need special attention. A warning does not lead to shutting down the wind turbine.

Typically, a control system of a wind turbine is coupled to a monitoring system which receives and stores, on a data storage, operational data relating to the operation of the wind turbine.

Such operational data may specifically comprise information relating to the setting and resetting of various alarms and warnings being send to the control system, but also relate to information associated with the magnitude of the power produced by the wind turbine.

Accordingly, the operational data may represent valuable information in the process of determining the amount of time in which the wind turbine, or specific parts thereof, have been operating properly or improperly, and especially may represent valuable data relating to the power being produced by the wind turbine at a given time or period of time.

As already indicated such information is used when dividing the value represented by the power produced by a wind turbine between the operator, operating the wind turbine on the one hand, and the manufacturer(s) of the wind turbine or parts thereof, on the other hand.

However, even in a situation in which no such contract exists or in a situation in which the term of such a contract has expired, it is of high interest for the operator of the wind turbine to continuously gain information relating to the operational state of the wind turbine, including information relating to the instant power production of the wind turbine in respect of different time segments.

Now, it may happen that the data received by the monitoring system from the control system and relating to operational data, is not being properly transmitted from the control system of the wind turbine to the monitoring system.

In case such relating data relates to the power being produced by the wind turbine at a given time or period of time, the data registered by the monitoring system does not represent an accurate picture of the efficiency the wind turbine during operation thereof.

It is clear that an inaccurate picture of the efficiency of a wind turbine during time periods of its operation will lead to an allocation of the value represented by the power produced by a wind turbine between the manufacturer and the operator in a way which deviates from the true situation and thereby the actual allocation of value being produced does not comply with the original intention as stipulated by the contract agreed between the operator and the manufacturer of the wind turbine.

In any event, even in a case no such contract exists or in a case where the term of such a contract has expired, it is still of high interest of the operator of the wind turbine to continuously gain information relating to the efficiency of the wind turbine.

The need to correctly monitor the amount of power being produced by a wind turbine applies equally well in respect of active power produced and reactive power produced by the wind turbine.

Accordingly, a need persists to improve reporting of operational data from a wind turbine during operation thereof.

The present invention in its various aspect seeks meet this need.

Accordingly, it is an objective of the present invention to provide methods, uses and devices which improves reporting of operational data from a wind turbine during operation thereof.

### BRIEF DESCRIPTION OF THE INVENTION

These objectives are fulfilled according to the first, the second, the third and the fourth aspect of the present invention.

In a first aspect the present invention relates to a method for improving reporting of operational data from a wind turbine during operation thereof; said method comprising the steps of:

i) controlling the operation of said wind turbine by using a control system;
ii) in respect of a predetermined time segment allowing one or more sensors to sense one or more parameter values representing the magnitude of power production of said wind turbine and allowing said sensors to transmit said one or more parameter values to said control system;
iii) from said one or more parameter values transmitted to said control system in step ii), allowing said control system to determine a total production of energy within said time segment;
iv) from said one or more parameter values transmitted to said control system, allowing said control system to determine an accumulated value, representing an accumulated production of energy by said wind turbine until the end of said specific time segment;
v) allowing said control system to transmit, to a monitoring system, data determined in step iii) and iv);
vi) repeat steps i)-v) in respect of subsequent time segments;
vii) in respect of a time span comprising several of said time segments, allowing said monitoring system to assess the reliability of data relating to the total production of energy in a specific time segment of said time span, and optionally allowing said monitoring system to correct such data in case such information is assessed as being unreliable, thereby obtaining corrected data relating to an estimated total production of energy in respect of one or more specific time segments within said time span.

In a second aspect the present invention relates to the use of interpolation of data relating to accumulated total energy produced by a wind turbine in respect of two separated time segments, separated by a specific time segment, for determining an estimated total energy production in respect of said specific time segment.

In a third aspect the present invention relates to a computer program product, which when loaded and/or operating on a computer, being configured for performing a method according to the first aspect of the present invention.

In a fourth aspect the present invention relates to a SCADA system (Supervisory Control And Data Acquisition System) comprising a computer program product as defined in respect of the third aspect of the present invention.

The present invention in its various aspects provides for improving the reporting of operational data being received by a monitoring system from a control system of a wind turbine during operation thereof.

Especially the present invention in its various aspects provides for correcting unreliable or missing data relating to energy production of a wind turbine.

Providing more reliable data relating to the actual amount of time in which a wind turbine has been operating properly and/or the actual amount of power produced will accordingly also provide a more accurate picture of the total time the wind turbine has been subjected to stresses by the weather and to wear and tear of the mechanical parts involved in the wind turbine. Knowing more accurately, the total time the wind turbine has been operating and/or the total amount of energy produced will accordingly allow for adhering more accurately to the maintenance protocols determined by the manufacturer of the wind turbine, and hence will secure a long-term life span of the wind turbine and will thus also enhance safety to personnel working in the vicinity of the wind turbine.

### BRIEF DESCRIPTION OF THE FIGURES

FIG. 1 schematically illustrates some of the components of a wind turbine employed in the present invention.

### DETAILED DESCRIPTION OF THE INVENTION

### The First Aspect of the Present Invention

In a first aspect the present invention relates to a method for improving reporting of operational data from a wind turbine during operation thereof; said method comprising the steps of:

i) controlling the operation of said wind turbine by using a control system;
ii) in respect of a predetermined time segment allowing one or more sensors to sense one or more parameter values representing the magnitude of power production of said wind turbine and allowing said sensors to transmit said one or more parameter values to said control system;
iii) from said one or more parameter values transmitted to said control system in step ii), allowing said control system to determine a total production of energy within said time segment;
iv) from said one or more parameter values transmitted to said control system, allowing said control system to determine an accumulated value, representing an accumulated production of energy by said wind turbine until the end of said specific time segment;
v) allowing said control system to transmit, to a monitoring system, data determined in step iii) and iv);
vi) repeat steps i)-v) in respect of subsequent time segments;
vii) in respect of a time span comprising several of said time segments, allowing said monitoring system to assess the reliability of data relating to the total production of energy in a specific time segment of said time span, and optionally allowing said monitoring system to correct such data in case such information is assessed as being unreliable, thereby obtaining corrected data relating to an estimated total production of energy in respect of one or more specific time segments within said time span.

Accordingly, in the method of the first aspect of the present invention using data available allows one to gain information relating to an accumulated production of energy in a specific time span in a situation where such data is not directly available.

In the description and in the appended claims the definition of the invention of the first aspect includes the term “allowing” followed by an action which is allowed to be performed. In this respect it should be noted that the action following the term “allowing” is not to be construed as an optional feature which may or may not be included. Rather, the term “allowing” as used in the definitions of the present invention should be construed in such a way that, in the invention, the action following the term “allowing” indeed is carried out (obviously taking into account any stated or implied conditional prerequisite).

In one embodiment of the method according to the first aspect of the present invention the data being assessed as being unreliable by said monitoring system, for one or more of the following reasons:
data in respect of one or more of said time segments to be transmitted by said control system has not been received by said monitoring system; and/or
data relating to accumulated production of energy by said wind turbine indicates that said accumulated production decreases over time; and/or
data relating to accumulated production of energy by said wind turbine indicates that said accumulated production increases over time by more than is theoretically possible, considering the nominal maximum power of said wind turbine; and/or
replacement of storage medium in control system, such as flash drive; and/or
wrong value manually entered by a technician; and/or
data relating to accumulated production of energy by said wind turbine jumps unreliably due to replacement of a controller or the control; and/or
intentional or unintentional correction of the system clock of the control system; and/or
intentional or unintentional correction of the system clock of the monitoring system and/or
synchronizing data from one monitoring system to another monitoring system.

In one embodiment of the method according to the first aspect of the present invention the parameter values representing power production of said wind turbine as determined in step ii) relates to one or more of the following:
average power produced in respect of said time segment; and/or
total production of energy in respect of said time segment.

In one embodiment of the method according to the first aspect of the present invention data being assessed as being unreliable is being corrected by interpolation of data.

Hereby is achieved with the method of the first aspect to provide more accurate data relating to the productivity of the wind turbine.

In one embodiment of the method according to the first aspect of the present invention and in respect of a specific segment in respect of which the total production of energy in that time segment is assessed as being unreliable, said estimated total production of energy is found by performing an interpolation between data relating to an accumulated production of energy by said wind turbine until the end of a first time segment and data relating to an accumulated production of energy by said wind turbine until the end of a second time segment; wherein said first time segment is preceding said specific segment, and wherein said second time segment is following said specific time segment.

Interpolation of such data provides in a reliable way data representing a more accurate picture of the operational status of the wind turbine, especially in terms of the productivity of the wind turbine.

In one embodiment of the method according to the first aspect of the present invention the time span is having a duration selected from the ranges 1-300 min., such as 2-270 min, e.g. 3-240 min., such as 4-210 min., such as 5-180 min., e.g. 6-120 min, such as 7-90 min, e.g. 8-60 min, such as 9-45 or 10-30 min.

Such time spans have proven suitable in exercising the method of the first aspect of the present invention.

In one embodiment of the method according to the first aspect of the present invention time segments is having a duration selected from the ranges 0.1-1800 s, such as 0.5-1500 s, such as 1-1200 s, for example 2-900 s, such as 3-600 s, such as 4-500 s, for example 5-400 s, such as 6-300 s, e.g. 7-200 s, such as 8-150 s, e.g. 9-100 s, such as 10-80 s, such as 15-60 s or 30-45 s.

These durations of time segments are suitable for being employed in the method according to the first aspect of the present invention.

In one embodiment of the method according to the first aspect of the present invention each time segment within said time span are having equal durations.

Hereby the handling of data becomes less complicated.

In one embodiment of the method according to the first aspect of the present invention the method is being performed automatically.

In one embodiment of the method according to the first aspect of the present invention the method is being performed continuously or regularly in respect of successive time spans.

These two embodiments in a conveniently way ensures continuous improvement of reporting of operational data.

In one embodiment of the method according to the first aspect of the present invention the one or more of said sensors in step ii) senses one or more parameter values representing active power production of said wind turbine and/or reactive power production of said wind turbine and/or active energy produced by said wind turbine and/or reactive energy produced by said wind turbine.

Hereby a more accurate picture reflecting the true operational situation of the wind turbine can be obtained.

In one embodiment of the method according to the first aspect of the present invention the method involves keeping a data log, logging a data set originating from said monitoring system and relating to one or more of the following entries: data determined in step ii) and/or iii) and/or iv); time stamps of start and/or end of individual time segments within said time span; corrected data as determined in step vii); time stamps relating to the start and/or end of said time span.

Keeping a data log ensures the ability to inspect data which has been logged at a point in time subsequent to the time of logging.

In one embodiment of the method according to the first aspect of the present invention the corrected data as determined in step vii) relates to an estimated total production of energy in one or more specific time segments of said time span.

In one embodiment of the method according to the first aspect of the present invention the a first original data log is being kept which logs and stores original data received by the monitoring system; and wherein a second data log is being kept, which logs and stores logs corrected data which represents original data which has been corrected by the method according to the invention of the first aspect.

Hereby the original data is easily distinguishable from the corrected data.

### The Second Aspect of the Present Invention

In a second aspect the present invention relates to the use of interpolation of data relating to accumulated total energy produced by a wind turbine in respect of two separated time segments, separated by a specific time segment, for determining an estimated total energy production in respect of said specific time segment.

In one embodiment of the use according to the second aspect of the present invention the data relating to accumulated total energy produced by a wind turbine in respect of said specific time segment is data which is missing or which is considered unreliable.

In one embodiment of the use according to the second aspect of the present invention, the use involves determination, by measurement, of said accumulated total energy produced in respect of said two separated time segments.

### The Third Aspect of the Present Invention

In a third aspect the present invention relates to a computer program product, which when loaded and/or operating on a computer, being configured for performing a method according to the first aspect of the present invention.

### The Fourth Aspect of the Present Invention

In a fourth aspect the present invention relates to a SCADA system (Supervisory Control And Data Acquisition System) comprising a computer program product as defined in respect of the third aspect the present invention.

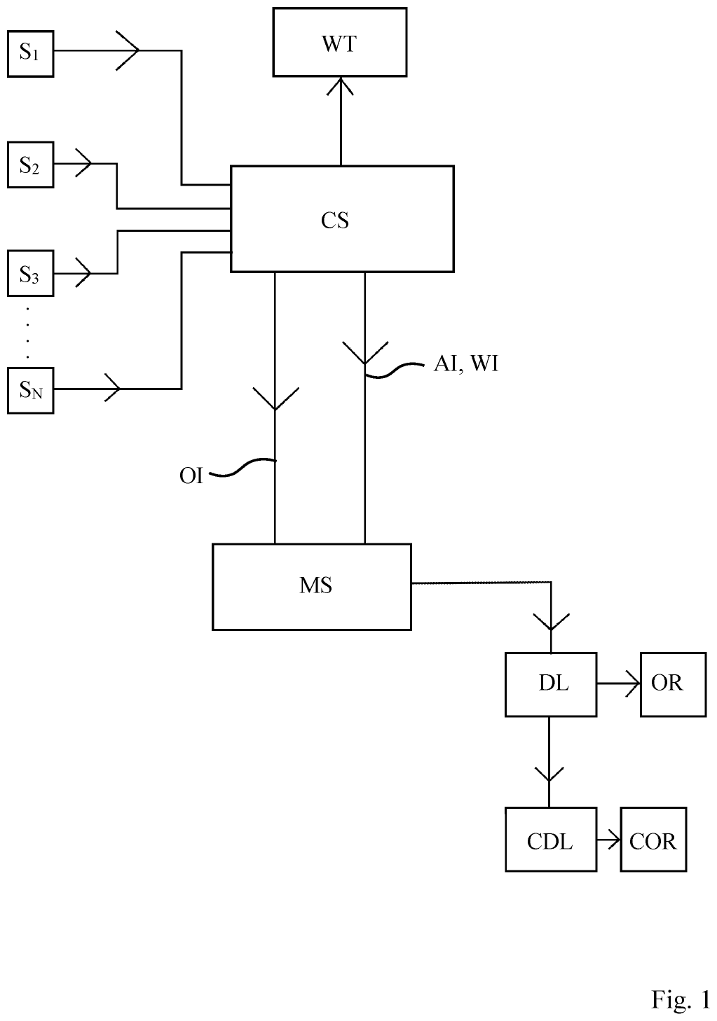

Referring to the FIGURE in order to better illustrating the present invention, FIG. 1 is a schematic diagram which in a very simplified manner illustrates the operation of a wind turbine.

FIG. 1 shows the wind turbine WT which is being controlled by a control system CS according to a predetermined control algorithm. A number of sensors S₁, S₂, S₃ . . . S_{N} sense various parameter values during the operation of the wind turbine. These parameter values are being transmitted to the control system CS.

Accordingly, the parameter values being transmitted to the control system is used as input in the algorithm determining a proper feedback reaction in respect of operating the wind turbine.

Various operation data is being sent to a monitoring system MS during operation of the wind turbine.

In addition to merely receiving parameter values from the sensors S₁, S₂, S₃ . . . S_{N} and providing feedback in the operation of the wind turbine, the control system CS is also configured, from the parameter values received from the sensors S₁, S₂, S₃ . . . S_{N}, to determine whether or not a critical event has been encountered which could jeopardize the short time and/or long time integrity of the wind turbine or components thereof. The determination of whether or not a critical event has occurred is being provided according to a predetermined algorithm.

In case the control system detects that a critical event is present, the control system instruct the wind turbine WT to shut down.

The control system is also configured, from the data received from the sensors S₁, S₂, S₃ . . . S_{N} to provide a warning in case certain components or combination(s) thereof need special attention. A warning will not cause the wind turbine to shut down.

Accordingly, the control system CS provides the monitoring system MS with operational information OI relating to the operational state of the wind turbine WT, with alarm information AI relating to settings og one or more alarms during the operation of the wind turbine and warning information WI relating to the provision of warnings which need special attention during operation of the wind turbine WT.

Part of the operational information OI may relate to the instant power being produced by the wind turbine, either momentarily or during a time segment, such as being expressed as an average power production during such time segment.

The information relating to instant power being produced by the wind turbine is sensed by one or more of the sensors S₁, S₂, S₃ . . . S_{N}.

The operational information OI, the alarm information AI and the warning information WI received by the monitoring system MS may be logged in a data log DL. From the data log DL may be retrieved an operational report OR, setting out details relating to the operation of the wind turbine, especially the duration of time periods at which the wind turbine WT or specific components thereof are operating properly or not properly.

The operational report OR is used in the calculation of the sharing of the value represented by the power produced by the wind turbine between the operator of the wind turbine on the one hand and the manufacturer of the wind turbine, or parts thereof on the other hand.

Besides, valuable information relating to the power being produced can be inspected from the operational report OR for the purpose of general interest.

In a situation in which, for whatever reason, the monitoring system MS does not receive correct information relating to the operational information OI, it is clear that the data log DL, from which the operational report OR is retrieved, will not reflect the true operational state of the wind turbine WT.

In case the data which the monitoring system has not received, related to power being produced valuable and reliable information relating to the true efficiency of the wind turbine will not be available.

Thereby, the calculation of the value represented by the power produced by the wind turbine, and the allocation thereof, between the operator of the wind turbine on the one hand manufacturer of the wind turbine, or parts thereof on the other hand, will not be performed in accordance with the original intentions agreed upon.

Besides, in general in such a situation a correct picture of the efficiency of the wind turbine will not be available.

The present invention in its various aspects seeks to alleviate or even eliminate such problems.

Referring to FIG. 1 again, the corrected or estimated information obtained in the method of the first aspect of the present invention may be logged in a corrected data log CDL from which a corrected operational report COR may be retrieved.

### EXAMPLES

### Example 1

This example illustrates the operation of a 3 MW wind turbine being operated by a control system.

The control system receives one or more parameter values representing power production of said wind turbine from one or more sensors being coupled to that control system. From the parameter values being transmitted from the sensor(s), the control system determines a total production of power in respect of successive time segment.

Moreover, the control system also calculates an accumulated value, representing an accumulated production of energy by the wind turbine until the end of each of the time segments.

The information relating to a total production of power in respect of successive time segments and the information relating to accumulated production of power by the wind turbine until the end of each of the time segment are being transmitted to a monitoring system.

Table 1 below illustrates data which has been transmitted by the control system and which has been received by the monitoring system.

TABLE 1

| | | | Accumulated production |
|---|---|---|---|
| Time stamp | | Energy | of energy by wind |
| at end of | Average power | production in | turbine until the end of |
| segment | produced (kW) | segment (kWh) | said time segment (kWh) |
| 10:00 | 2,400 | 400 | 231,423,1000 |
| 10:10 | 2,400 | 400 | 231,423,1400 |
| 10:20 | 2,400 | 400 | 231,423,1800 |
| 10:30 | No data | No data | No data |
| 10:40 | No data | No data | No data |
| 10:50 | 2,400 | 400 | 231,423,2600 |
| 11:00 | 2,400 | 400 | 231,423,3000 |
| 11:10 | 2,400 | 400 | 8,231,423,8000 |
| 11:20 | 2,400 | 400 | 8,231,423,8400 |

Table 1 illustrates data collected in a time span having end points ranging from 10:00 to 11:20. Successive time segments are separated by a period of time of 10 min.

It is seen in table 1 that the control system has registered time stamps in respect of data detected. These time stamps appears in the leftmost column. Moreover, as appearing from the second column, also data relating to the average power produced in respect of each time segment of 10 min.

From the first two columns, the control system calculates the energy production in each time segment (the product of duration of each time segment and the average power produced in that time segment). These values appear in the third column of table 1.

Finally, the control system has also transmitted to the monitoring system data relating to an accumulated production of energy by wind turbine until the end of said time segment. This data appears in the rightmost column.

Now, for some reason data has been missed in the transmission from the control system to the monitoring system. The missing data is data in respect of time segments of 10 min. duration ending at 10:30 and 10:40, respectively.

Accordingly, without taken any actions, the monitoring system would have to exclude information relating to the energy production produced in the time segments ending at 10:30 and 10.40, respectively.

However, the method of the first aspect of the present invention, enables providing an estimation of the total production of power in respect of these time segments.

These estimates are arrived at by performing an interpolation between the accumulated production of energy by wind turbine (last column) in respect of the time segment ending immediately before the time segment ending at 10:30 (i.e. the time segment ending at 10:20) and the time segment ending immediately subsequent to the time segment ending at 10:40 (i.e. the time segment ending at 10:50).

Hereby, in respect of the time segments ending at 10:30 and 10:40, respectively, we find that an estimated energy production in the time segments ending at 10:30 and 10:40, respectively is:

(231,423,2600 kWh−231,423,1800 kWh−400 kWh)/2=200 kWh.

It is also seen in Table 1 that somewhere in the period between 11:00 and 11:10 the data relating to accumulated production of energy by wind turbine until the end of the corresponding time segment suddenly jumps by a very large magnitude (from 231,423,3000 kWh to 8,231,423,8000 kWh). As the wind turbine of this example is a 3 MW turbine, it is clear that the value of 8,231,423,8000 kWh cannot be correct.

In case the information relating to an accumulated production of energy by the wind turbine until the end of said time segment was the only information being logged by the monitoring system, no proper reporting relating to the energy production in the segment relating to the period of time from 11:00 to 11:10 would have been possible, because this data would necessarily have to be calculated from the data relating to accumulated production of energy (rightmost column).

According to the method of the first aspect of the present invention it is possible to provide an estimation of the magnitude of the energy production in the segment of time ranging from 11:00 to 11:10.

Accordingly, using the data relating to average power produced in the specific segment ranging from 11:00 to 11:10 (=2,400 kW), the estimated energy production in the segment ranging from 11:00 to 11:10 can be assessed as:

2,400 kW×⅙ h=400 kWh.

This value may accordingly be logged and stored, such as in a corrected data log, as an estimated total production of energy in respect of the time segment ranging from 11:00 to 11.10.

Moreover, the estimated total production of energy in respect of the time segment ranging from 11:00 to 11:10 of 400 kWh may be employed to provide estimated data relating to the accumulated production of energy by wind turbine until the end of the time segment ending at 11:10. This estimated data would then be:

231,423,3000 kWh+400 kWh=231,423,3400 kWh.

### Example 2

In this example the same wind turbine with its corresponding components as employed in Example 1 is used.

Table 2 below illustrates data which has been transmitted by the control system and which has been received by the monitoring system.

TABLE 2

| | | | Accumulated production |
|---|---|---|---|
| Time stamp | | Energy | of energy by wind |
| at end of | Average power | production in | turbine until the end of |
| segment | produced (kW) | segment (kWh) | said time segment (kWh) |
| 10:00 | 2,400 | 400 | 231,423,1000 |
| 10:10 | 2,400 | 400 | 231,423,1400 |
| 10:20 | No data | No data | No data |
| 10:30 | No data | No data | No data |
| 10:40 | 2,400 | 400 | 600 |
| 10:50 | 2,400 | 400 | 1,000 |

It is seen in Table 2 to that the monitoring system misses date transmitted from the control system in respect of the time segments having end points at 10:20 and 10:30, respectively.

It is also seen from Table 2 that during the period of time of missing data, the counter counting an accumulated production of energy by wind turbine until the end of said time segment (rightmost column in Table 2), has been reset (as evidenced by the fact that the counter is at 600 kWh at the end of the time segment ending at 10:40).

The estimated total production of energy in respect of the time segments ending at 10:20 and 10:30, respectively can be estimated as:

(600 kWh−400 kWh)/2=100 kWh.

This value may accordingly be logged and stored, such as in a corrected data log, as an estimated total production of energy in respect of the time segment ending at 11:20 and 11:3, respectively.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

WT Wind turbine
CS Control system
MS Monitoring system
DL Data log
OR Operational report originating from Data log
CDL Corrected data log
COR Corrected operational report originating from Corrected data log
AI Alarm information
WI Warning information
OI Operational information
S₁ Sensor No. 1 monitoring the operation of the wind turbine
S₂ Sensor No. 2 monitoring the operation of the wind turbine
S₃ Sensor No. 3 monitoring the operation of the wind turbine
S_{N} Sensor No. N monitoring the operation of the wind turbine

1. A method for improving reporting of operational data from a wind turbine (WT) during operation thereof; said method comprising the steps of:
i) controlling the operation of said wind turbine (WT) by using a control system (CS);
ii) during a predetermined time segment allowing one or more sensors (S₁, S₂, S₃, . . . , S_{N}) to sense one or more parameter values representing the magnitude of power production of said wind turbine and allowing said sensors to transmit said one or more parameter values to said control system (CS);
iii) from said one or more parameter values transmitted to said control system (CS) in step ii), allowing said control system to determine a total production of energy within said time segment;
iv) from said one or more parameter values transmitted to said control system (CS), allowing said control system to determine an accumulated value, representing an accumulated production of energy by said wind turbine until the end of said specific time segment;
v) allowing said control system (CS) to transmit, to a monitoring system (MS), data determined in step iii) and iv);
vi) repeating steps i)-v) during subsequent time segments;
vii) over a time span comprising several of said time segments, allowing said monitoring system (MS) to assess the reliability of data relating to the total production of energy in a specific time segment of said time span, and optionally allowing said monitoring system (MS) to correct such data in case such information is assessed as being unreliable, thereby obtaining corrected data relating to an estimated total production of energy during one or more specific time segments within said time span.

2. A method according to claim 1, wherein in step vii) said data being assessed as being unreliable by said monitoring system (MS), for one or more of the following reasons:
data in respect of one or more of said time segments to be transmitted by said control system (CS) not been received by said monitoring system (MS); and/or
data relating to accumulated production of energy by said wind turbine (WT) indicates that said accumulated production decreases over time; and/or
data relating to accumulated production of energy by said wind turbine (WT) indicates that said accumulated production increases over time by more than is theoretically possible, considering the nominal maximum power of said wind turbine; and/or
replacement of storage medium in control system, such as flash drive; and/or
wrong value manually entered by a technician; and/or
data relating to accumulated production of energy by said wind turbine (WT) jumps unreliably due to replacement of a controller or the control; and/or
intentional or unintentional correction of the system clock of the control system; and/or
intentional or unintentional correction of the system clock of the monitoring system and/or
synchronizing data from one monitoring system to another monitoring system.

3. A method according to claim 1, wherein said parameter values representing power production of said wind turbine as determined in step ii) relates to one or more of the following:
average power produced in respect of said time segment; and/or
total production of energy in respect of said time segment.

4. A method according to claim 1, wherein in step vii) said data being assessed as being unreliable is being corrected by interpolation of data.

5. A method according to claim 4, wherein in respect of a specific segment in respect of which the total production of energy in that time segment is assessed as being unreliable, said estimated total production of energy is found by performing an interpolation between data relating to an accumulated production of energy by said wind turbine until the end of a first time segment, and data relating to an accumulated production of energy by said wind turbine until the end of a second time segment; wherein said first time segment is preceding said specific segment, and wherein said second time segment is following said specific time segment.

6. A method according to claim 1, wherein said time span has a duration selected from the ranges 1-300 min.

7. A method according to claim 1, wherein said time segments has a duration selected from the ranges 0.1-1800 s.

8. A method according to claim 1, wherein each time segment within said time span has equal durations.

9. A method according to claim 1, wherein said method is performed automatically.

10. A method according to claim 1, wherein said method is performed continuously or regularly in respect of successive time spans.

11. A method according to claim 1, wherein one or more of said sensors (S₁, S₂, S₃, . . . , S_{N}) in step ii) senses one or more parameter values representing active power production of said wind turbine and/or reactive power production of said wind turbine and/or active energy produced by said wind turbine and/or reactive energy produced by said wind turbine.

12. A method according to claim 1, wherein said method involves keeping a data log, logging a data set originating from said monitoring system (MS) and relating to one or more of the following entries: data determined in step ii) and/or iii) and/or iv); time stamps of start and/or end of individual time segments within said time span; corrected data as determined in step vii); and time stamps relating to the start and/or end of said time span.

13. A method according to claim 12, wherein said corrected data as determined in step vii) relates to an estimated total production of energy in one or more specific time segments of said time span.

14. A method according to claim 1, wherein said method involves keeping a data log, logging a data set originating from said monitoring system (MS) and relating to one or more of the following entries: data determined in step ii) and/or iii) and/or iv); time stamps of start and/or end of individual time segments within said time span; corrected data as determined in step vii); and time stamps relating to the start and/or end of said time span;
wherein a first original data log (DL) is being kept which logs and stores original data received the monitoring system; and wherein a second data log (CDL) is being kept, which logs and stores logs corrected data which represents original data which has been corrected by the method according to claim 1.

15. (canceled)

16. (canceled)

17. (canceled)

18. A computer program product, which when loaded and/or operating on a computer, configures said computer for performing a method according to claim 1.

19. A SCADA system (Supervisory Control And Data Acquisition System) comprising a computer program product as defined in claim 18.
